(19) United States
(12) Patent Application Publication
(10) Pub. No.: US 2025/0298699 A1
(43) Pub. Date: Sep. 25, 2025

(54) APPARATUS FOR DETERMINING BACKUP CONFIGURATION OF STORAGE SYSTEM

(71) Applicant: Hitachi Vantara, Ltd., Yokohama-shi (JP)

(72) Inventors: Yuto KAMO, Tokyo (JP); Mitsuo HAYASAKA, Tokyo (JP); Nobuhiro YOKOI, Tokyo (JP); Tomohiro YOSHIHARA, Tokyo (JP)

(21) Appl. No.: 18/829,457

(22) Filed: Sep. 10, 2024

(30) Foreign Application Priority Data
Mar. 21, 2024 (JP) 2024-044751

(51) Int. Cl. G06F 11/14

(52) U.S. Cl. CPC G06F 11/1464; G06F 2201/84

(57) ABSTRACT

An apparatus determines a backup configuration of a storage system. The storage system includes a plurality of front-end interfaces. The apparatus stores configuration determination information. The configuration determination information includes network performance information indicating the performance of a network between the storage system and the backup destination, interface performance information indicating the performance of the front-end interfaces, and performance requirement information indicating a performance requirement for the host IO. The apparatus determines, on the basis of the configuration determination information, a front-end interface that reads the backup data and a front-end interface that transmits the backup data to the backup destination.

### CLAIM OF PRIORITY

The present application claims priority from Japanese patent application JP 2024-044751 filed on Mar. 21, 2024, the content of which is hereby incorporated by reference into this application.

### BACKGROUND OF THE INVENTION

### 1. Field of the Invention

The present invention relates to a backup configuration of a storage system.

### 2. Description of the Related Art

The hybrid cloud storage market is expanding. One of the primary use cases for hybrid cloud storage is backups to cloud storage. In addition, because it is necessary to transfer data of a huge volume from an on-premises storage system to cloud storage, a high transfer performance is required for the backup software.

U.S. Pat. No. 8,156,293 constitutes background art of the present disclosure. In the storage system disclosed in U.S. Pat. No. 8,156,293, the plurality of first storage control modules processes I/O operations related to data stored in a disk device in communication with each storage control module, designates a first type of storage control software which is installed in the first storage control module of the storage control modules from among a plurality of types of storage control software that can be installed and executed by the first storage control module, and installs the designated first type of storage control software in the first storage control module such that the first storage control module executes the first type of storage control software in order to process I/O operations of the first type.

### SUMMARY OF THE INVENTION

Backup processing can be executed by applying the related art to a front-end interface. In backup processing, encoding processing such as encryption processing or compression processing is performed on data which is read from a storage drive (also referred to as a disk or a storage device) in order to perform a transfer to a backup destination.

For example, when the line band between the storage system and the backup destination becomes wider, the backup performance becomes lower than the line band. This is because, in order to provision the CPU and the memory of the same front-end interface to processing for reading data from the storage drive (also referred to as a disk) and to backup processing, only part of the CPU and the memory is provisioned to the backup processing.

Thus, the appropriate backup configuration of the storage system may change according to conditions such as storage system performance and the network bandwidth.

One embodiment of the present invention is an apparatus for determining a backup configuration of a storage system, the apparatus including: a processor; and a memory apparatus, in which the storage system includes a plurality of front-end interfaces, in which the memory apparatus stores configuration determination information,
the configuration determination information including:
network performance information indicating performance of a network between the storage system and a backup destination, interface performance information indicating performance of the front-end interfaces, and
performance requirement information indicating a performance requirement for a host IO, and in which the processor determines, on the basis of the configuration determination information, a front-end interface that reads backup data and a front-end interface that transmits the backup data to the backup destination.

According to one aspect of the present invention, an appropriate backup configuration of the storage system can be determined.

### BRIEF DESCRIPTION OF THE DRAWINGS

FIG. 1 is a configuration diagram schematically illustrating a backup configuration according to a first embodiment;

FIG. 2 is a hardware configuration diagram of a storage system according to the first embodiment;

FIG. 3 is a hardware configuration diagram of an FE (front-end) I/F according to the first embodiment;

FIG. 4A shows a configuration example of backup configuration information;

FIG. 4B shows a configuration example of backup configuration information;

FIG. 5 shows a flowchart of backup processing by means of two FE I/Fs;

FIG. 6 shows a flowchart of fault handling processing using the FE I/Fs;

FIG. 7 is a configuration diagram schematically illustrating a backup configuration according to a second embodiment;

FIG. 8 is a hardware configuration diagram of a storage system according to the second embodiment;

FIG. 9 shows a flowchart of backup processing according to the second embodiment;

FIG. 10 is a configuration diagram schematically illustrating a backup configuration according to a third embodiment;

FIG. 11 is an example of a configuration diagram of a management apparatus;

FIG. 12 shows a flowchart of backup processing according to the third embodiment;

FIG. 13 shows a flowchart of fault handling processing according to the third embodiment;

FIG. 14 is a configuration diagram schematically illustrating a backup configuration according to a fourth embodiment;

FIG. 15 shows a flowchart of backup processing according to the fourth embodiment;

FIG. 16 shows a configuration example of configuration determination information;

FIG. 17 shows a configuration example of backup configuration management information;

FIG. 18 shows a flowchart of backup configuration determination processing according to a fifth embodiment; and

FIG. 19 shows a flowchart of backup configuration determination processing according to a sixth embodiment.

### DESCRIPTION OF THE PREFERRED EMBODIMENTS

Hereinafter, various embodiments will be described with reference to the drawings. These embodiments do not limit the scope of the claims of the present invention, and not all the elements described in the embodiments are necessary to solve the problems of the present invention. In the following description, when it is necessary for convenience, the description will be divided into a plurality of sections or embodiments, but unless otherwise specified, the sections or embodiments are not unrelated to each other, with one section or embodiment being related to some or all modifications, details, supplementary explanations, and so forth of another section or embodiment. Furthermore, in the following description, when referring to numbers of elements and the like (including numbers, numerical values, amounts, ranges, and the like), the numbers of elements are not limited to specific numbers, and unless otherwise stated and unless clearly limited in principle to specific numbers, the number of elements may be equal to or greater than, or equal to or less than, the specific numbers.

In an embodiment of the present specification, a SmartNIC (Network Interface Card) is mounted in the storage system, and SmartNIC-type storage is assumed, in which protocol processing is offloaded to the SmartNIC from the processor of a controller (also referred to as the storage controller) for performing data access control of the storage system.

A SmartNIC is a front-end interface apparatus which is a highly functional network card that enables functions desired by a user to be programmed (added) by means of software or hardware. The SmartNIC is capable of executing functions of, for example, a network layer, a transport layer, and an application layer above the transport layer, in addition to communication processing, which is performed using a conventional network card, of a physical layer and a data link layer.

The following description of a SmartNIC can also be applied to an interface apparatus having a programmable logic circuit configuration such as a field programmable gate array (FPGA) as well as to an interface apparatus in which a function can be programmed by means of software executed by a processor. The FPGA may include a logic circuit that implements each function implemented by a program, and cache memory that is used in arithmetic operations.

In an embodiment of the present specification, a backup configuration of a storage system is determined on the basis of preset conditions. As a result, an appropriate backup configuration can be determined on the basis of the state of the storage system which includes a connected network. Hereinafter, after some backup configurations of the storage system are described, a method for determining the backup configuration of the storage system will be described.

### First Embodiment

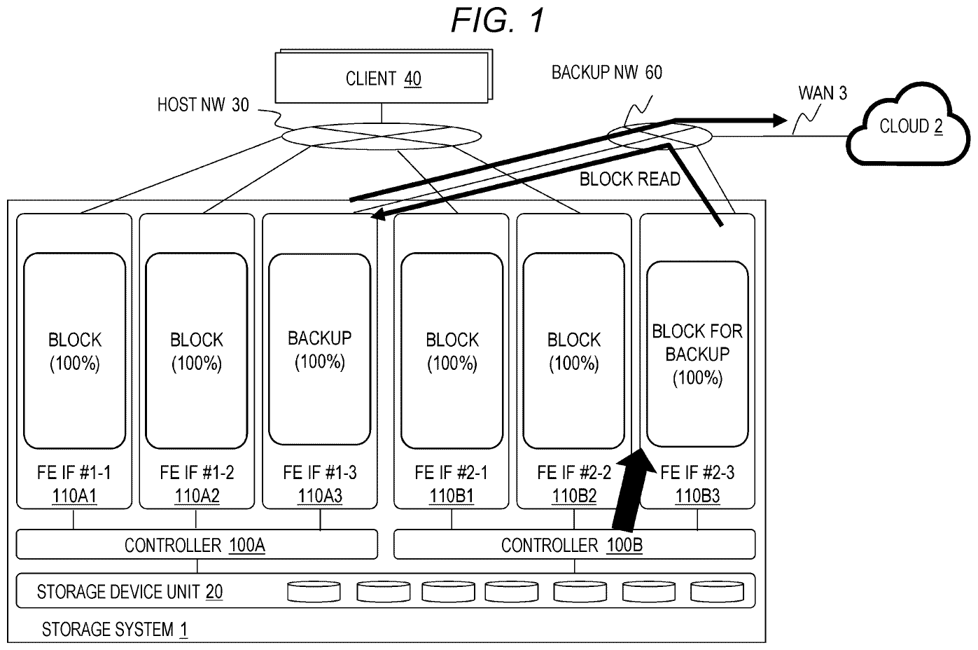

FIG. 1 is a configuration diagram schematically illustrating a backup configuration according to a first embodiment. A client 40 performs 10 access to a storage system 1 via a host network 30. The 10 access includes data reading and data writing from a storage device unit 20. The storage device unit 20 includes a plurality of storage devices (also called storage drives). The host network 30 is, for example, a local area network (LAN).

The storage system 1 includes one or a plurality of controllers and a plurality of front-end interfaces (FE I/Fs). In the configuration example shown in FIG. 1, the storage system 1 includes two controllers 100A and 100B, three FE I/Fs 110A1, 110A2, and 110A3 of the controller 100A, and three FE I/Fs 110B1, 110B2, and 110B3 of the controller 100B. In FIG. 1, although the FE I/Fs are arranged outside the controllers to facilitate the description, the FE I/Fs may be contained within the controllers. Arbitrary controllers shown in FIG. 1 represent the controllers 100, and arbitrary FE I/Fs represent the FE I/Fs 110.

The FE I/Fs 110 execute block processing. The block processing is block protocol processing, and is, for example, iSCSI Target. The block processing passes a request to the controller 100 in accordance with a read or write request received from a request source (for example, the client 40). The controllers 100 transfer data from the storage device unit 20 to the request source or write data received from the request source to the storage device unit 20.

A SmartNIC is used as the FE I/Fs 110, and the FE I/Fs 110 are capable of executing protocol processing. In the present embodiment, the storage system 1 is block storage, and iSCSI is assumed as the communication protocol between the client 40 and the storage system 1. The storage system 1 need not be block storage, rather, other communication protocols such as, for example, FC-SCSI (Fibre Channel Small Computer System Interface), NVMe/TCP, NVMe/RDMA (Remote Direct Memory Access), and FC NVMe can be used.

The storage system 1 executes backup processing (a backup processing sequence), to the cloud storage, of data stored in the storage device unit 20. The storage system 1 transmits the backup data to the cloud storage of the cloud 2 via a wide area network (WAN) 3. The backup processing may be executed, for example, in volume units. Note that the backup destination may be an on-premises storage connected via a network.

In the present embodiment, the two FE I/Fs 110, which form a pair, execute backup processing from the storage system 1 to cloud storage. The FE I/Fs 110 of the different controllers 100A and 100B form a pair. The two FE I/Fs 110 are inserted, removed and managed as a pair.

Because the FE I/Fs 110 included in different controllers 100 form a pair, redundancy can be increased. For example, in the example shown in FIG. 1, the FE I/F 110A3 and the FE I/F 110B3 execute backup processing. Note that two FE I/Fs 110 of the same controller 100 may execute the backup processing.

In the configuration example shown in FIG. 1, the FE I/F 110A3 uses the FE I/F 110B3 to control execution of the backup processing. Specifically, the FE I/F 110A3 issues a request to the FE I/F 110B3 to perform block processing for backup. The block processing for backup includes reading the backup data from the storage device unit 20 unit.

The FE I/F 110A3 acquires, from the FE I/F 110B3, the backup data read from the storage device unit 20, performs predetermined encoding processing (including, for example, encryption and compression processing) on the data, and transfers the data to the backup destination.

The FE I/F 110A3 issues a request to the FE I/F 110B3 to transfer the backup data designating the address of the backup data via a backup network 60. The backup network 60 is, for example, a LAN. The backup network 60 may also be common to the host network 30.

The FE I/F 110B3 reads designated backup data from the storage device unit 20 via the controller 100B, and transfers the backup data to the FE I/F 110A3 via the backup network 60. This is similar to block processing in response to an IO request from a host.

The FE I/F 110A3 performs predetermined encoding processing (processing) on the acquired backup data. The encoding processing can include encryption, compression, conversion to a format for backup, and the like. The FE I/F 110A3 transmits the processed backup data to the cloud storage in the cloud 2 at the backup destination via the backup network 60 and a WAN3. As described above, because different FE I/Fs 110 execute the backup processing and the block processing for backup, it is possible to reduce the possibility of the FE I/F 110 constituting a bottleneck and of the processing time of the backup becoming long.

Here, the FE I/Fs 110A3 and 110B3 are not in charge of block processing for the IO from the client 40. In this example, the FE I/Fs 110A3 and 110B3 are connected to the backup network 60 and are not connected to the host network 30. Therefore, the impact of the backup on IOs from the client 40 can be avoided. Note that the FE I/Fs 110A3 and 110B3 are also connected to the host network 30, and thus the host processing may also be executed outside the backup processing period.

Note that the other FE I/Fs 110A1, 110A2, 110B1, and 110B2 execute block processing for the client 40 and are removed from the backup processing sequence. In this example, the FE I/Fs 110A1, 110A2, 110B1, and 110B2 are connected to the host network 30 and are not connected to the backup network 60. The FE I/Fs 110A1, 110A2, 110B1, and 110B2 may be connected to the backup network 60.

All the processor cores of the FE I/F 110A3 are not exclusively provisioned to processes (applications) other than the backup processing, and all the processor cores can execute the backup processing. In addition, all the processor cores of the FE I/F 110B3 are not exclusively provisioned to processes (applications) other than block processing, and thus all the processor cores are capable of executing block processing. As described above, the FE I/Fs 110A3 and 110B3 do not receive IOs from the client 40 during the backup processing sequence.

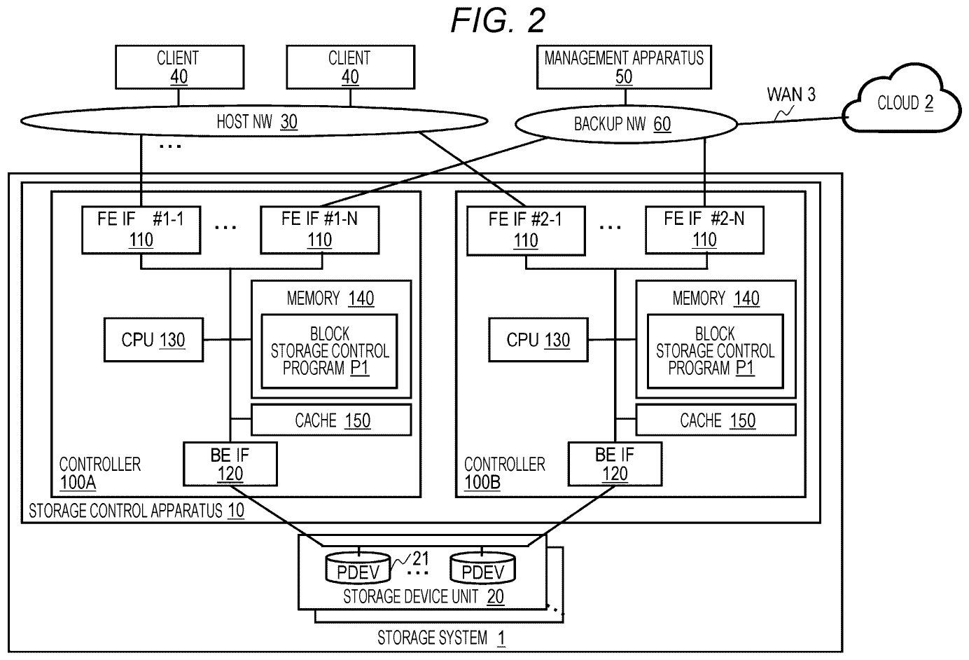

FIG. 2 is a hardware configuration diagram of the storage system 1 according to the first embodiment. The storage system 1 is connected to the client 40 via the host network 30. The storage system 1 is connected to a management apparatus 50 via the backup network 60. The backup network 60 is connected to the cloud 2 via the external WAN3.

The storage system 1 includes a storage control apparatus 10 and a storage device unit 20. The storage control apparatus 10 includes a plurality of controllers, and two controllers 100A and 100B are illustrated in FIG. 2. In order to improve the availability of the storage system 1, a dedicated power supply may be prepared for each controller 100, and power may be supplied to each controller 100 using the dedicated power supply. In addition, there may be a plurality of storage control apparatuses 10, and the controllers 100 may be connected to each other via a host channel adaptor (HCA) network.

The controllers 100A and 100B have the same configuration. The controllers 100 each include a plurality of FE I/Fs 110, a back-end interface (BE I/F) 120, a CPU 130 as a processor, memory 140 as main storage, and a cache 150. The foregoing components are connected to each other by means of a communication path such as a bus, for example.

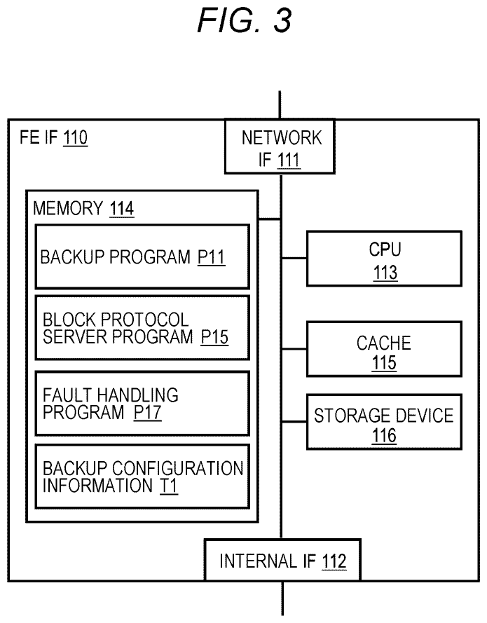

The FE I/Fs 110 are programmable network interfaces for which a SmartNIC or the like is used. Block protocol processing and backup processing are performed on the FE I/Fs 110. The FE I/Fs 110 will be described below in detail with reference to FIG. 3. The BE I/Fs 120 are interface devices that enable the controllers 100 to communicate with the storage device unit 20.

The CPU 130 controls the operation of the block storage. The memory 140 is, for example, a random access memory (RAN), and temporarily stores programs and data in operational control by the CPU 130. The memory 140 stores a block storage control program P1. The cache 150 temporarily stores write data from the client 40 or the FE I/F 110 and data read from the storage device unit 20. The data stored in the memory 140 may be stored in the storage device unit 20.

The block storage control program P1 provides a logical device (LDEV), which is a logical storage area based on the storage device unit 20, to the FE I/Fs 110. The FE I/Fs 110 are capable of accessing any LDEV. As a result, the FE I/Fs 110 are capable of using the LDEV as a storage destination for the data of the client 40.

The storage device unit 20 includes a plurality of PDEVs 21. The PDEVs 21 use a hard disk drive (HDD) or another type of storage device (nonvolatile storage device), for example, a flash memory (FM) device such as a solid state drive (SSD). The storage device unit 20 may have different types of PDEVs 21. In addition, a RAID group may be configured from a plurality of PDEVs 21 of the same type. Data is stored in the RAID group according to a predetermined RAID level.

The client 40 is an apparatus that accesses the storage system 1, and transmits data input/output requests (data write requests and data read requests) to the storage system 1. The client 40 transmits a data input/output request in units of blocks to the storage system 1.

The management apparatus 50 includes a user interface such as a graphical user interface (GUI) or a command line interface (CLI), and provides a function for a user or an operator to control and monitor the storage system 1.

FIG. 3 is a hardware configuration diagram of the FE I/Fs 110 according to the first embodiment. The FE I/Fs 110 each include a network I/F111, an internal I/F 112, a CPU 113, a memory 114, and a storage device 116. The foregoing components are connected to each other by means of a communication path such as a bus, for example. The memory 114, the storage device 116, and a combination thereof are memory apparatuses.

The network I/Fs 111 are interface devices for communicating with the client 40. The network I/Fs 111 are used as network ports for communication for which IP addresses are set. IP addresses are identifiers on the network, and the client 40 communicates with the FE I/Fs 110 via the IP addresses set for the ports.

The internal I/F 112 is an interface device that communicates with the controllers 100. The internal I/F 112 is connected to the CPU and the like of the controllers 100 by means of Peripheral Component Interconnect-Express (PCIe), for example.

The CPU 113 is a processor and controls the operation of the FE I/F 110. The memory 114 is main storage, and temporarily stores programs and data used for operational control by the CPU 113. The memory 114 stores a backup program P11, a block protocol server program P15, a fault handling program P17, and backup configuration information T1. Each program and information item stored in the memory 114 may be stored in the storage device 116. The backup program P11, a fault handling program P17, and the backup configuration information T1 may be stored only in the FE I/F110 that may control execution of the backup processing.

The backup program P11 controls execution of the backup processing. Details of the backup processing will be described below. The block protocol server program P15 receives various requests such as read/write requests from a request source and processes a block protocol included in the requests. The block protocol server program P15 processes the received requests and converts the requests into block access command requests to the controller 100. The block protocol server program P15 communicates with the CPU 130 of the controller 100 and processes data writing and reading with respect to the LDEV.

The cache 115 is a device (storage area) that temporarily stores user data, backup data, and the like transmitted/received to/from the client 40. The storage device 116 is a non-volatile storage device that stores programs, tables, and the like of the FE I/Fs 110, and employs a flash memory, for example.

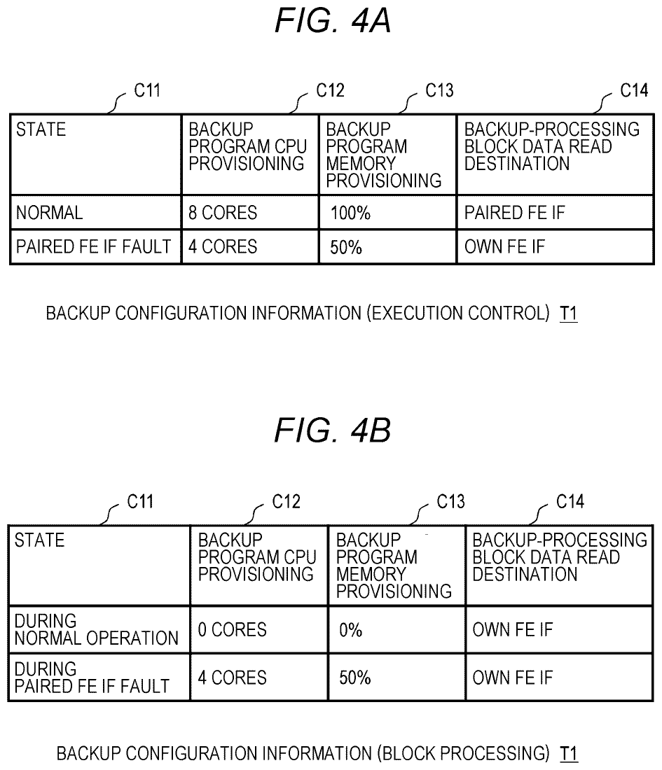

FIGS. 4A and 4B illustrate a configuration example of the backup configuration information T1. The backup configuration information T1 manages information for backup processing. FIG. 4A shows an example of the backup configuration information T1 stored in the FE I/Fs 110 that control execution of backup processing, and FIG. 4B shows an example of the backup configuration information T1 stored in the FE I/Fs 110 that execute block processing for backup.

The backup configuration information T1 includes a state field C11, a backup program CPU-provisioning field C12, a backup program memory-provisioning field C13, and a backup-processing block data read destination field C14.

The state field C11 indicates one of a normal state and a paired FE IF fault state. The normal state is a state in which the FE IF pair is operating without a fault. The paired FE IF fault state is a state in which a fault occurs in the other FE IF of the pair. Each entry indicates information on a normal state in which normal operation is performed or information on a state in which a fault occurs in a pair counterpart FE IF.

The backup program CPU-provisioning field C12 indicates the number of CPU cores provisioned to the backup program P11. The backup program P11 memory-provisioning field C13 indicates the percentage of the memory to be provisioned to the backup program P11. The backup-processing block data read destination field C14 indicates the FE IF 110 for reading data from the storage device unit 20.

FIG. 4A shows the content of the backup configuration information T1 held by the FE I/F 110A3 (see FIG. 1) that controls execution of the backup processing. The block data read destination in a normal state is the other FE IF 110B3 (see FIG. 1) forming the pair. In the FE IF 110A3, the number of CPU cores provisioned to the backup program P11 is 8, and the memory provisioning ratio is 100%. That is, all the CPU cores are provisioned.

In a case where a fault has occurred in the FE IF 110B3, the FE IF 110A3 (own FE IF) executes backup processing execution control and reading of backup data from the storage device unit 20. That is, the FE IF 110A3 executes block processing and encoding and transfer processing of the backup data read by the block processing. At this time, the number of CPU cores provisioned to the backup program P11 in the FE IF 110A3 is 4, and the memory provisioning ratio is 50%.

FIG. 4B shows the content of backup configuration information T1 held by the FE I/F 110B3 that executes block processing for backup. The block data read destination in the normal state is the FE IF 110B3 (own FE IF). In the FE IF 110B3, the number of CPU cores provisioned to the backup program P11 is 0, and the memory provisioning ratio is 0%. That is, the backup program P11 is not operating.

In a case where a fault has occurred in the FE IF 110A3, the FE IF 110B3 (own FE IF) executes backup processing execution control and reading of backup data from the storage device unit 20. That is, the FE IF 110B3 executes block processing, and encoding and transfer processing of the backup data read by the block processing. At this time, the number of CPU cores provisioned to the backup program P11 in the FE IF 110B3 is 4, and the memory provisioning ratio is 50%.

As described above, the backup configuration information T1 manages the hardware resources provisioned to the backup processing and the FE IF of the block data read destination of the backup processing, in the normal state and the fault state, respectively.

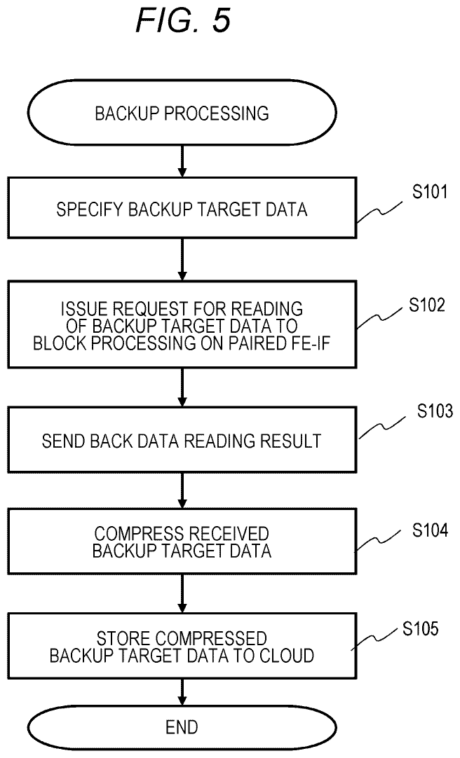

Next, an example of backup processing by the two FE I/Fs 110 will be described. FIG. 5 is a flowchart of backup processing performed by means of two FE I/Fs 110. Hereinafter, it is assumed that the FE I/Fs 110A3 and 110B3 illustrated in FIG. 1 execute backup processing.

First, the backup program P11 of the FE I/F 110A3 specifies data to be backed up (S101). Specifically, the storage address of the backup target is specified. The information of the backup target data can be transmitted from the client 40 or the management apparatus 50, for example.

Next, the backup program P11 issues a request for the block processing on the paired FE I/F 110B3 to read the backup target data (S102). Specifically, the backup program P11 transmits a read request designating the address of the backup target data to the FE I/F 110B3.

The block protocol server program P15 of the FE I/F 110B3 receives the read request from the FE I/F 110A3, reads the data of the address indicated by the read request from the storage device unit 20, and returns the data to the FE I/F 110A3 (S103). Specifically, the block protocol server program P15 converts the read request into an internal read command and transmits the internal read command to the CPU 130 of the controller 100B. The CPU 130 reads the data of the designated address from the storage device unit 20 from the storage device unit 20.

The FE I/F 110A3 stores the backup target data received from the FE I/F 110B3 in the cache 115, for example. The backup program P11 of the FE I/F 110A3 compresses the backup target data (S104). Note that different encoding processing may be executed instead of or in addition to compression. The backup program P11 transmits and stores the compressed backup target data to the cloud 2 via the networks 60 and 3 (S105).

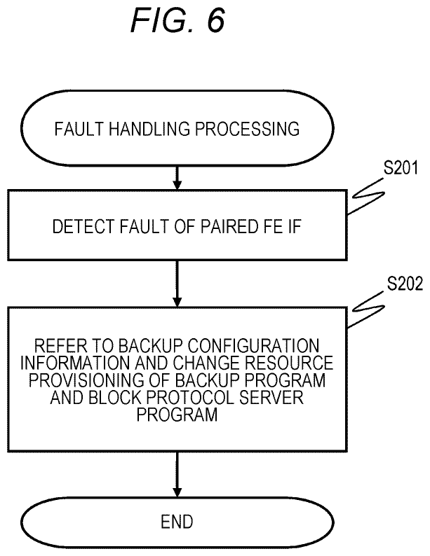

Next, processing of the FE I/F110 at the time of a fault will be described. FIG. 6 shows a flowchart of fault handling processing using the FE I/Fs 110. It is assumed that a fault has occurred in either one of the FE I/Fs 110A3 and 110B3. The fault handling program P17 of each of the FE I/Fs 110A3 and 110B3 is capable of monitoring the state of the other FE I/F 110 and detecting the generated fault. For example, a heartbeat signal may be used.

First, the fault handling program P17 detects a fault in the paired FE I/F 110 (S201). The fault handling program P17 refers to the backup configuration information T1 and changes the resource provisioning of the backup program P11 and the block protocol server program P15 (S202).

In a case where a fault occurs in one of the pair, the other FE I/F 110 in which no fault has occurred continues the backup processing. Therefore, when a fault occurs in one FE I/F110 of the pair, the program configuration operating in the other FE I/F 110 is changed to the basic method, that is, the configuration with which the backup program P11 and the block protocol server program P15 operate.

Specifically, in the FE I/F 110A3, in the normal state, 8 cores and 100% of memory are provisioned to the backup program P11, and zero cores are provisioned to the block protocol server program P15, that is, are not operating. When a fault occurs, four cores and 50% of the memory are provisioned to each of the backup program P11 and the block protocol server program P15.

Meanwhile, in the FE I/F 110B3, in the normal state, 8 cores and 100% of memory are provisioned to the block protocol server program P15, and 0 cores are provisioned to the backup program P11, that is, are not operating. When a fault occurs, four cores and 50% of the memory are provisioned to each of the backup program P11 and the block protocol server program P15.

### Second Embodiment

Other embodiments of the present specification will be described hereinbelow. In the following description, differences from the first embodiment will mainly be described. Unless otherwise stated, the description of the first embodiment may be applied to the present embodiment. In the present embodiment, the FE IF 110 that controls the execution of the backup processing issues a request to a FE IF 110 which is different from the FE IF 110 forming the pair to perform the block processing (total resource provisioning out-of-pair read configuration).

Different FE IFs 110 also process requests from the client 40. In a case where the bandwidth of the backup network 60 is insufficient or where the performance of the paired FE IF 110 is insufficient, the backup processing can be promptly executed by using another network or another FE IF 110.

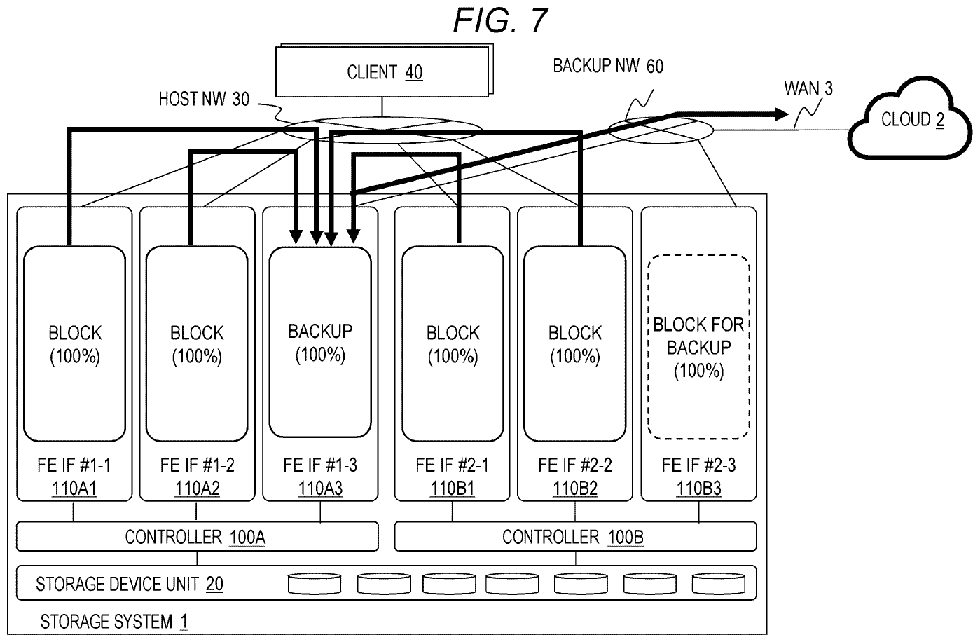

FIG. 7 is a configuration diagram schematically illustrating a backup configuration according to a second embodiment. As compared with the backup configuration illustrated in FIG. 1, the FE IF1110A3 issues a request to the other FE IFs 110A1, 110A2, 110B1, and 110B2 to perform block processing (reading) of the backup data instead of the FE IF 1110B3 forming the pair. In the configuration example illustrated in FIG. 2, the backup data is transferred to the FE IF 1110A3 via the host network 30.

The processing load can be distributed by requesting the plurality of FE IFs 110 to perform the block processing. Because the request destination of the block processing for backup also executes the block processing requested from the client 40, the impact on the processing can be reduced. The FE IF 1110A3 executes the backup program P11 and does not execute the block protocol server program P15. The host network 30 may enable faster transfer in a case where the bandwidth of the backup network 60 is insufficient. Note that, instead of or in addition to the host network 30, another dedicated network or internal communication (DMA or the like) may be used.

In the configuration example shown in FIG. 7, the backup target data is read via another FE IF 110 of the same controller 100A as the FE IF 110A3 and the FE IF 110 of the other controller 100B. The FE IF 110 that executes the block processing of the backup target data may be only the FE IF 110 of the same controller 100A as the FE IF 110A3 that transfers the data to the backup destination or only the FE IF 110 of a different controller 100B.

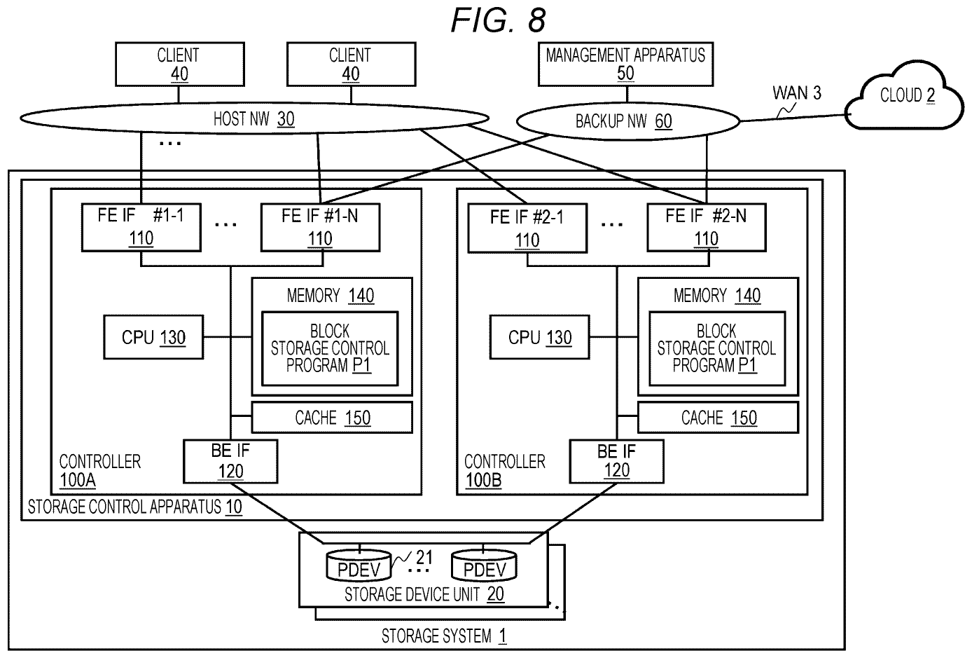

FIG. 8 is a hardware configuration diagram of the storage system 1 according to the second embodiment. As compared with the configuration example shown in FIG. 2, the FE IF 110 that controls execution of the backup processing and the FE IF 110 paired therewith are connected to the host network 30 in addition to the backup network 60. In a case where the backup data is transferred via a communication path different from the host network 30, such as an internal communication path, the aforementioned two FE IFs 110 need not be connected to the host network 30.

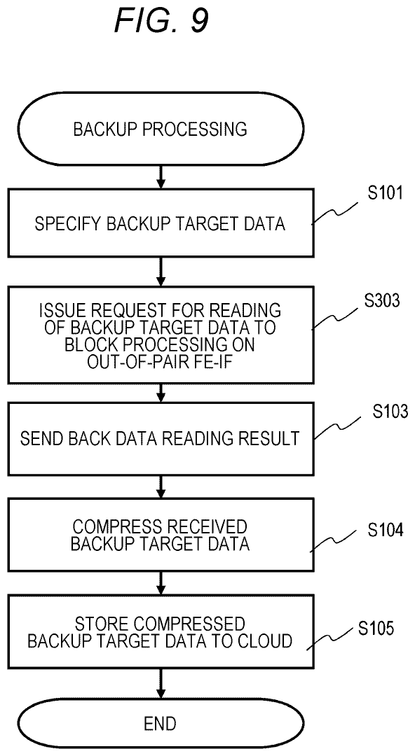

FIG. 9 shows a flowchart of backup processing according to the second embodiment. Steps other than step S303 are similar to the backup processing shown in FIG. 5. In step S303, the backup program P11 issues request for reading of backup target data to block processing on the out-of-pair FE IF 110.

Candidates for the request destination FE IF 110 are designated in advance in the FE IF 110A3. The FE IF 110A3 selects a request destination from among the request destination candidates. Selection methods include a method for using a round robin to make a selection for each I/O, and a method for checking the load of the FE IF 110 as a request destination candidate and selecting the FE IF 110 having a low load. The load information of the FE IFs 110 can be acquired from the FE IFs 110.

### Third Embodiment

Other embodiments of the present specification will be described hereinbelow. In the following description, differences from the first embodiment will mainly be described. Unless otherwise stated, the description of the first embodiment may be applied to the present embodiment. In the present embodiment, backup processing, that is, data reading from the storage device unit 20 and data transfer to the backup destination are distributed to the paired FE IF 110. In a case where the FE IF 110 is higher than the performance of the network, the backup processing can be executed quickly.

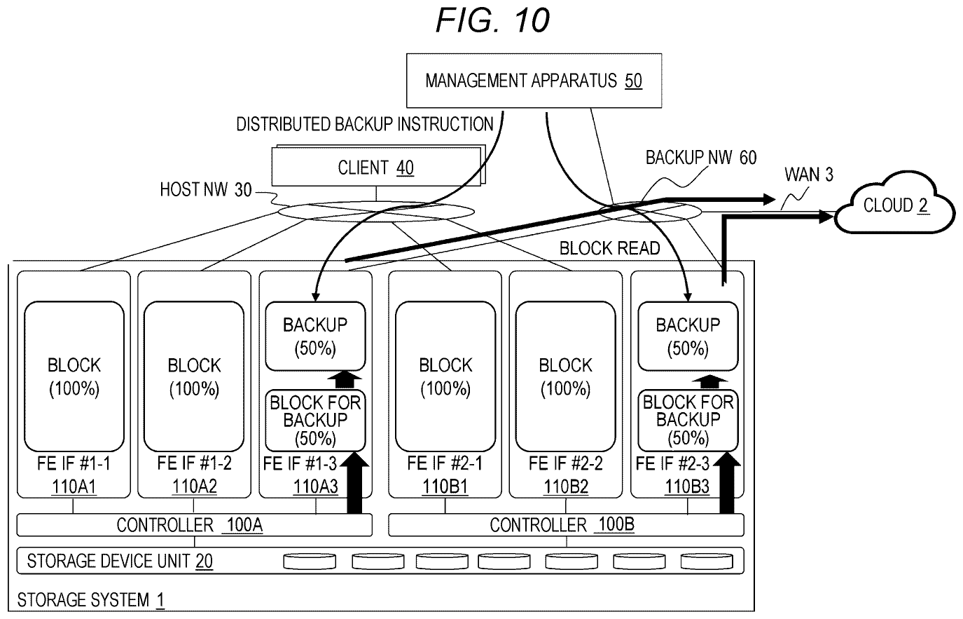

FIG. 10 is a configuration diagram schematically illustrating a backup configuration according to a third embodiment. As compared with the backup configuration shown in FIG. 1, each of the two FE IFs 110A3 and 110B3 executes backup processing execution control and backup data block processing. That is, each of the FE IFs 110A3 and 110B3 executes the backup program P11 and the block protocol server program P15.

In the configuration example shown in FIG. 10, the management apparatus 50 issues a backup instruction designating an address to each of the paired FE IFs 110A3 and 110B3. The management apparatus 50 is connected to the backup network 60. Note that this instruction may be transmitted from the controller 100 or the client 40.

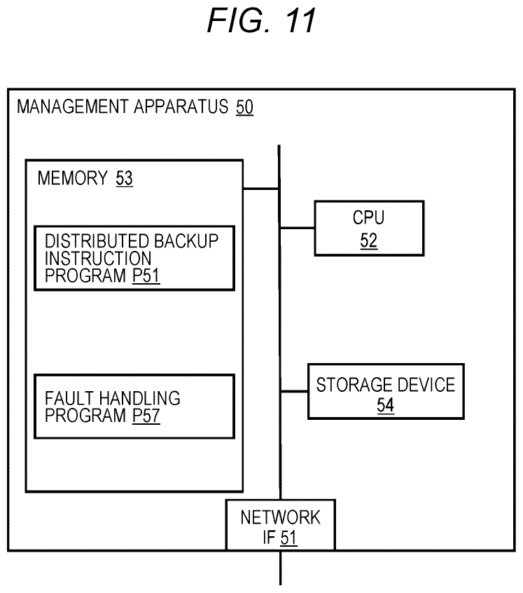

FIG. 11 is an example of a configuration diagram of the management apparatus 50. The management apparatus 50 includes a network I/F 51, a CPU52 which is a processor, memory 53, and a storage device 54. The memory 53, the storage device 54, and a combination thereof are memory apparatuses. The foregoing components are connected to each other by a communication path such as a PCI Express (Peripheral Component Interconnect Express) bus, for example.

The network I/F 51 is an interface device for communicating with the storage system 1 and the client 40. The CPU 52 controls the operation of the management apparatus 50. The memory 53 temporarily stores programs and data used for operational control by the CPU 52. The memory 53 stores a distributed backup instruction program P51 and a fault handling program P57. Each program and information stored in the memory 53 may be stored in the storage device 54. The storage device 54 stores programs and tables of the management apparatus 50.

The distributed backup instruction program P51 instructs the plurality of FE IFs 110 executing the backup processing to perform the backup processing in which the backup target data is designated. The fault handling program P57 monitors the states of the plurality of FE IFs 110 executing the backup processing, and executes the handling processing in a case where a fault occurs in any of the FE IFs 110.

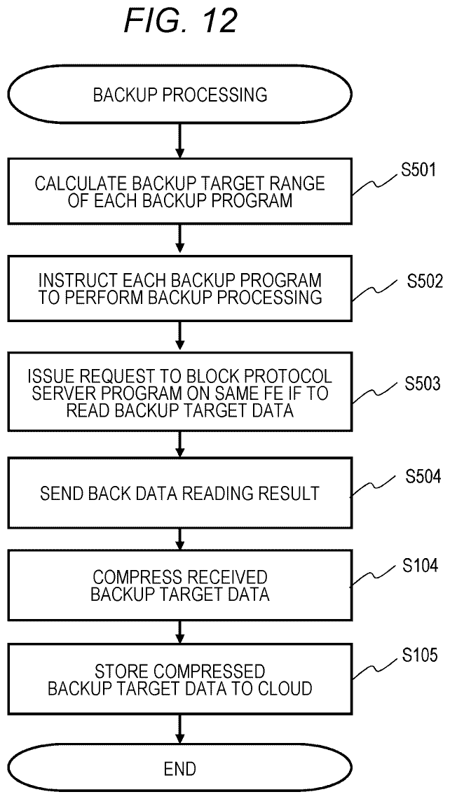

FIG. 12 shows a flowchart of backup processing according to the third embodiment. The distributed backup instruction program P51 computes a backup target range of each backup program P11 (S501). Next, the distributed backup instruction program P51 instructs each backup program to perform backup processing (S502). The instruction designates backup target data.

The backup program P11 that has received the instruction from the distributed backup instruction program P51 issues a request to the block protocol server program P15 on the same FE IF 110 to read the backup target data (S503). The block protocol server program P15 reads the designated backup target data from the storage device unit 20 and returns the data to the backup program P11 (S504). The subsequent steps S104 and S105 are as described with reference to FIG. 5.

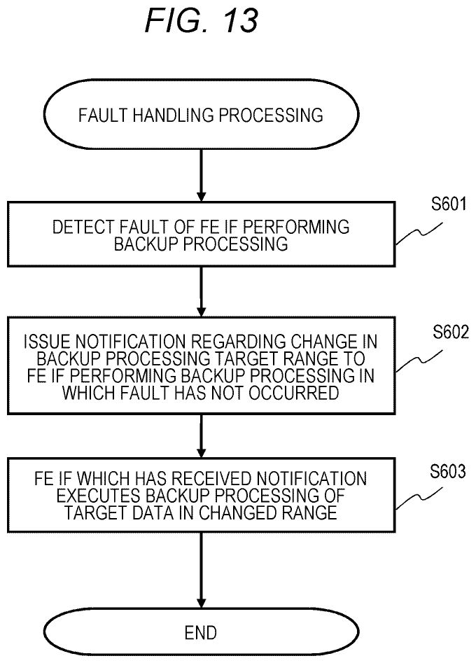

Next, processing in a case where a fault occurs in the FE IF 110 executing the backup processing will be described. FIG. 13 is a flowchart of fault handling processing according to the third embodiment. The fault handling program P57 monitors the state of the FE IF 110 executing the backup processing. The state monitoring may use, for example, heartbeat communication.

The fault handling program P57 detects a fault that has occurred in the FE IF 110 executing the backup processing (S601). The fault handling program P57 specifies unprocessed backup target data which is the backup target data of the FE IF 110 in which the fault has occurred. The progress state of the backup processing may be reported from the FE IF 110 to the management apparatus 50 as needed. The fault handling program P57 notifies the FE IF 110 performing the backup processing, in which one or more faults have not occurred, of the change in the backup processing target range so as to include unprocessed backup target data (S602). The backup program P11 of the FE IF 110 that has received the notification executes backup processing of the changed backup processing target range (S603).

### Fourth Embodiment

Other embodiments of the present specification will be described hereinbelow. Hereinafter, differences from other embodiments will be mainly described. Unless otherwise stated, the description of the other embodiments may be applied to the present embodiment. In the present embodiment, each of the plurality of FE IFs 110 executes the backup program P11 without performing the block processing, and issues a request to another FE IF 110 executing the host processing to perform block processing of the backup target data. Execution control of the backup processing is executed by the plurality of FE IFs 110, thus enabling the load thereof to be reduced.

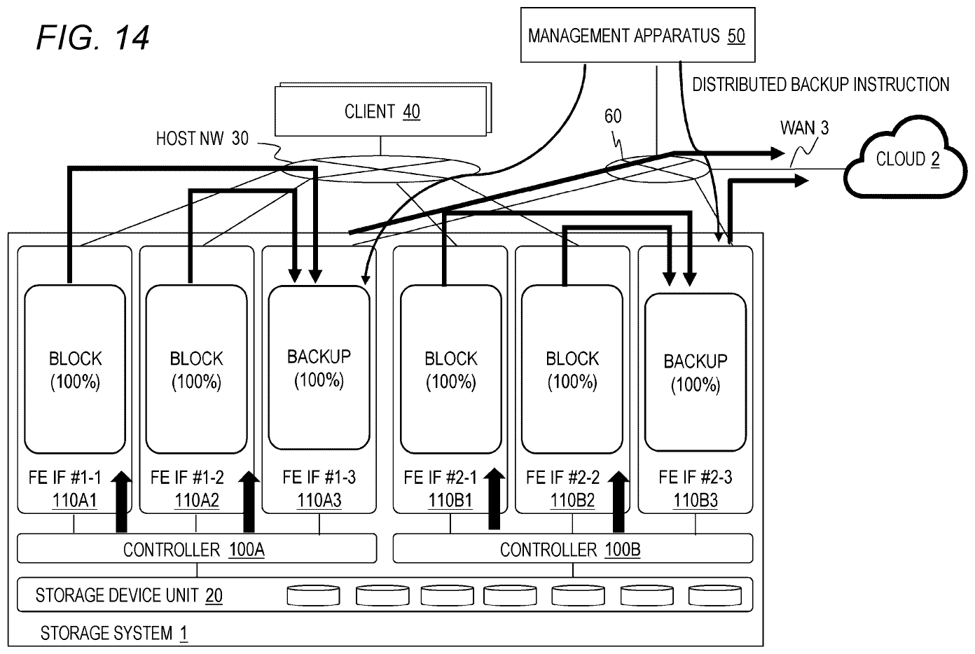

FIG. 14 is a configuration diagram schematically illustrating a backup configuration according to a fourth embodiment. As compared with the configuration example shown in FIG. 7, the FE IF 110B3 controls execution of the backup processing in addition to the FE IF 110A3. The foregoing FE IFs form a pair. The FE IFs 110A3 and 110B3 execute the backup program P11 and do not execute the block protocol server program P15. The FE IFs 110A3 and 110B3 issue a request to the different FE IFs 110 to perform block processing of the backup data.

In the configuration example shown in FIG. 14, the FE IFs 110A3 and 110B3 issue a request to the other plurality of FE IFs 110 of the same controller 100 to perform the block processing of the backup data. The FE IF 110A3 may issue a request to the FE IF 110 of the different controller 100B to perform block processing of the backup data. Similarly, the FE IF 110B3 may issue a request to the FE IF 110 of a different controller 100A to perform block processing of the backup data.

Similarly to the description with reference to FIG. 10, the management apparatus 50 issues a backup instruction designating an address to each of the paired FE IFs 110A3 and 110B3. The management apparatus 50 is connected to the backup network 60. Note that this instruction may be transmitted from the controller 100 or the client 40.

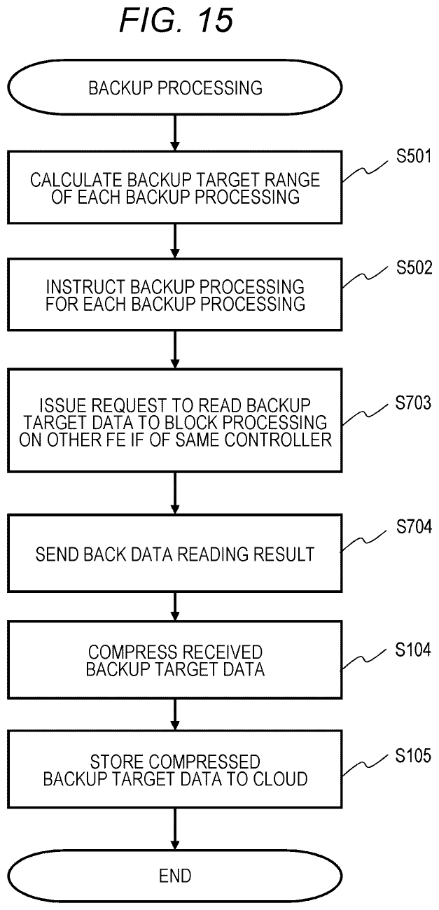

Next, backup processing according to the fourth embodiment will be described. FIG. 15 shows a flowchart of backup processing according to the fourth embodiment. The distributed backup instruction program P51 computes a backup target range of each backup program P11 (S501). Next, the distributed backup instruction program P51 instructs each backup program to perform backup processing (S502). The instruction designates backup target data.

The backup program P11, which has received the instruction from the distributed backup instruction program P51, issues a request to the block protocol server program P15 on another FE IF 110 of the same controller 100 to read the backup target data (S703). The block protocol server program P15 reads the designated backup target data from the storage device unit 20 and returns the data to the backup program P11 to the request source FE IF 110 (S704). The subsequent steps S104 and S105 are as described with reference to FIG. 5.

The candidates for the request destination FE IF 110 are designated in advance in the FE IFs 110A3 and 110B3. The FE IF 110A3 selects a request destination from among the request destination candidates. Selection methods include a method for using a round robin to make a selection for each I/O, and a method for checking the load of the FE IF 110 as a request destination candidate and selecting the FE IF 110 having a low load. The load information of the FE IFs 110 can be acquired from the FE IFs 110.

### Fifth Embodiment

Other embodiments of the present specification will be described hereinbelow. The present embodiment describes a method for selecting a backup configuration to be applied to the storage system 1 from among a plurality of backup configuration candidates. Specifically, an appropriate backup configuration is selected from the total resource provisioning pair read configuration (configuration 1) described in the first embodiment, the total resource provisioning out-of-pair read configuration (configuration 2) described in the second embodiment, and a basic configuration. The basic configuration is a configuration in which only one FE IF 110 executes the backup program P11 and the block protocol server program P15.

Which backup configuration is suitable differs depending on the line bandwidth and requirements of the customer. For example, in the total resource provisioning pair read configuration (configuration 1) which is the backup configuration in the normal state described in the first embodiment, it is expected that the backup processing performance is improved two or more times as compared with the basic configuration. On the other hand, unlike the basic configuration, the total resource provisioning pair read configuration (configuration 1) requests the paired FE IF 110 to transmit a block I/O for backup, and thus consumes the bandwidth of the backup NW60. As a result, the basic configuration may be suitable depending on the backup NW60 bandwidth. In addition, because the configuration at the time of a fault is similar to the basic configuration, the backup performance is lower than that of the total resource provisioning pair read configuration (configuration 1) in the normal state.

The total resource provisioning out-of-pair read configuration (configuration 2), which is the backup configuration in the normal state described in the first embodiment, similarly consumes the bandwidth of the host NW30. Therefore, the basic configuration and the total resource provisioning pair read configuration (configuration 1) may be more suitable depending on the bandwidth and host performance requirements of the host NW30.

In the present embodiment, a backup configuration to be constructed is determined according to line bandwidth (WAN bandwidth or LAN bandwidth) and the requirements (backup requirement or host performance requirement) of the customer, and is set for the storage system 1. For determination and setting of the backup configuration, predetermined management information is referred to. The present embodiment refers to configuration determination information and backup configuration management information. The setting of the backup configuration may be executed by, for example, the management apparatus 50, the controller 100, or an administrator. The reference information may be implemented in these apparatuses or other apparatuses.

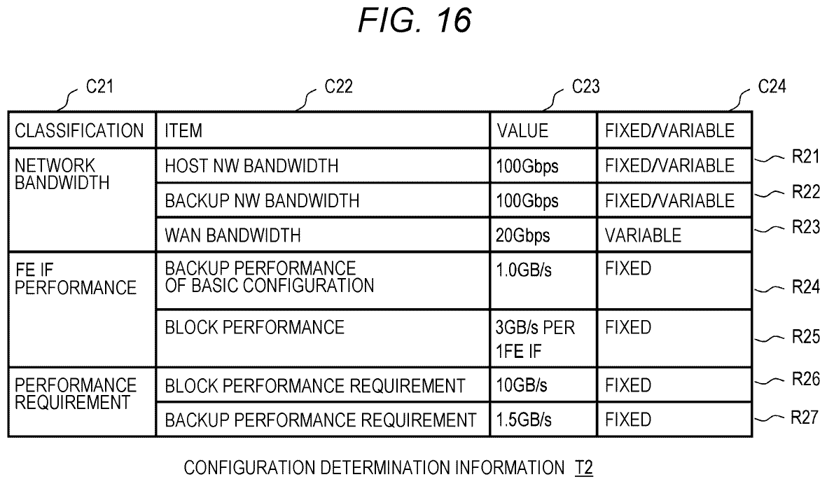

FIG. 16 shows a configuration example of the configuration determination information T2. The configuration determination information T2 includes information on conditions for determining the backup configuration. The configuration determination information T2 includes a classification field C21, an item field C22, a value field C23, and a fixed/variable field C24. The classification field C21 indicates the classifications of items to be referred in the determination of the backup configuration. In the configuration example shown in FIG. 16, the network bandwidth and the performance and performance requirements of the FE IFs are registered.

The item field C22 indicates items referred to in the determination of the backup configuration. In the configuration example shown in FIG. 16, items classified as network bandwidths include a host network bandwidth, a backup network bandwidth, and a WAN bandwidth. Items classified as the performance of the FE IFs include backup performance and block performance of the basic configuration. Items classified as performance requirements include a block performance requirement and a backup performance requirement.

The value field C23 indicates the values of each item indicated by the item field C22. The fixed/variable field C24 indicates whether the values indicated by the value field C23 are fixed values or variable values. Fixed values are not updated in the configuration determination information T2. On the other hand, the variable value is updated in a timely manner, for example, periodically.

Entry R21 indicates information on the host network bandwidth. The value is 100 Gbps, which is a fixed value or a variable value. If the value is a fixed value, the value registered first is maintained, and if the value is a variable value, the value is updated as needed. Entry R22 indicates information of the backup network bandwidth. The value is 100 Gbps, which is a fixed value or a variable value. If the value is a fixed value, the value registered first is maintained, and if the value is a variable value, the value is updated as needed. Entry R23 indicates information of the WAN bandwidth. The value is 20 Gbps, which is a fixed value.

Entry R24 indicates information on the backup performance of the basic configuration. The value is 1.0 GB/s, which is a fixed value. As described above, the backup performance of the basic configuration is data transfer performance when only one FE IF 110 reads the backup data from the storage device unit 20 and transfers the backup data to the cloud 2.

Entry R25 indicates information on block performance per FE IF. Specifically, the block performance indicates data reading performance when the FE IF 110 executes the block protocol server program P15 without executing the backup program P11. The value is 3 GB/s per FE IF.

Entry R26 indicates information on the block performance requirement. The block performance requirement indicates a requirement for response performance from the storage system 1 to an IO request from the client 40. The block performance requirement is a requirement required for the total block performance of all the FE IFs 110 responding to the request from the client 40. This value is 10 GB/s.

Entry R27 indicates information on the backup performance requirement. The backup performance requirement is a performance requirement required for the backup processing of the storage system 1. The backup performance requirement is a requirement for transfer performance of backup data from the storage system 1 to the cloud 2. This value is 1.5 GB/s.

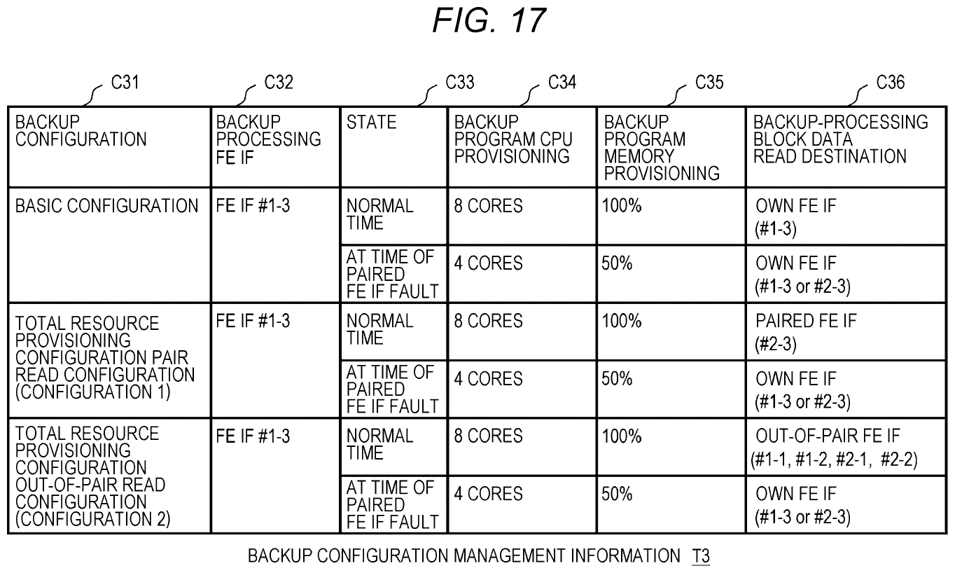

FIG. 17 shows a configuration example of backup configuration management information T3. The backup configuration management information T3 includes information on backup configurations serving as selection candidates. In the configuration example shown in FIG. 17, the backup configuration management information T3 includes a backup configuration field C31, a backup processing FE IF field C32, a state field C33, a backup program CPU-provisioning field C34, a backup program memory-provisioning field C35, and a backup-processing block data read destination field C36.

The backup configuration field C31 indicates the name of the backup configuration to be selected. Here, two backup configurations 1 (first backup configuration), a backup configuration 2 (second backup configuration), and a basic configuration described in the first embodiment and the second embodiment are shown. The backup configuration 1 is a total-resource provisioning configuration pair read configuration, and the backup configuration 2 is a total-resource provisioning configuration out-of-pair read configuration.

The backup processing FE IF field C32 indicates the FE IF 110 that executes the backup program P11 in each backup configuration. The state field C33 indicates a normal state or a fault state of the FE IF pair. The fault state is a state in which a fault occurs in only one FE IF 110. The backup program CPU-provisioning field C34 and the backup program memory-provisioning field C35 indicate the CPU cores and the memory provisioning amount for the backup program P11, respectively. The backup-processing block data read destination field C36 indicates an FE IF that reads data from the storage device unit 20 in the backup processing.

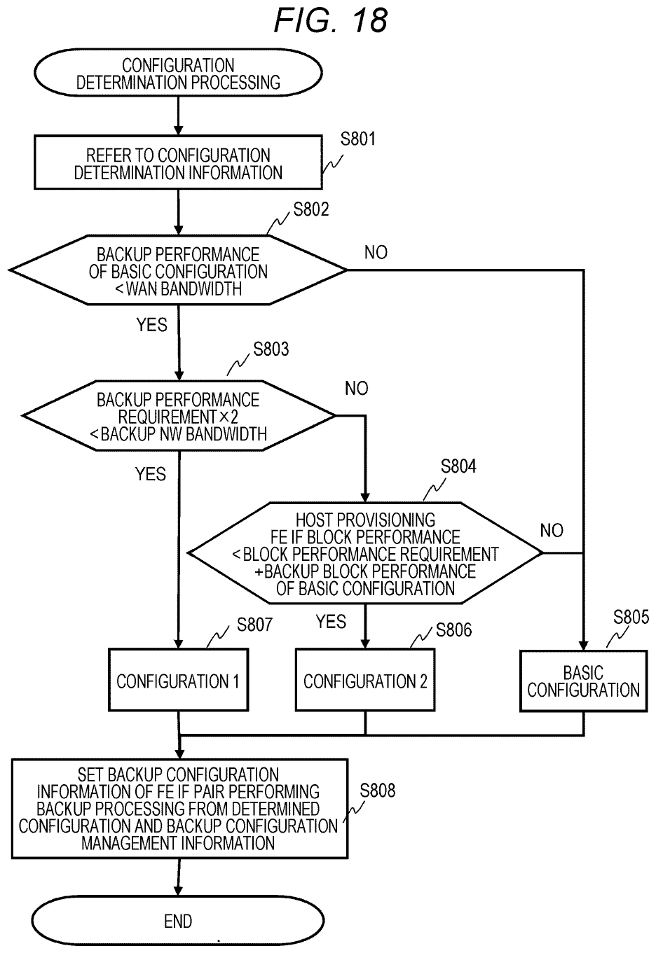

Next, backup configuration determination processing according to the present embodiment will be described. FIG. 18 shows a flowchart of backup configuration determination processing according to a fifth embodiment. Hereinafter, an example in which the management apparatus 50 executes the processing will be described, but the subject is not particularly limited.

The management apparatus 50 refers to the configuration determination information T2 (S801) and compares the backup performance of the basic configuration with the WAN bandwidth (S802). It is determined whether the WAN bandwidth is a bottleneck in the basic configuration. In a case where the backup performance of the basic configuration is equal to or higher than the WAN bandwidth (S802: NO), the management apparatus 50 selects the basic configuration as the backup configuration set for the storage system 1 (S805).

In a case where the backup performance of the basic configuration is smaller than the WAN bandwidth (S802: YES), the management apparatus 50 compares a value obtained by doubling the backup performance requirement with the backup network bandwidth (S803). In the backup configuration 1, it is determined whether the backup network 60 is short on bandwidth. In a case where the value obtained by doubling the backup performance requirement is smaller than the backup network bandwidth (S803: YES), the management apparatus 50 selects the backup configuration 1 as the backup configuration to be set for the storage system 1 (S807).

In a case where the value obtained by doubling the backup performance requirement is equal to or greater than the backup network bandwidth (S803: NO), the management apparatus 50 compares the block performance of the host provisioning FE IF 110 processing the request from the client 40 with the sum of the block performance requirement and the block performance in the backup processing of the basic configuration (S804). Whether the performance becomes lower than that of the basic configuration is determined by using the host network 30 in backup processing.

The block performance of the host provisioning FE IF 110 is the sum of the block performances of all the host provisioning FE IFs 110. Using the information shown in FIG. 16 as an example, the block performance of the host provisioning FE IF 110 is 3 GB/s×4=12 GB/s.

The block performance requirement is 10 GB/s. The basic configuration backup block performance is block performance in one FE IF 110 that executes the backup processing in the basic configuration. Here, the basic configuration backup block performance is half the block performance of the FE IF 110 that executes only block processing. That is, the value is 3 GB/s×50%=1.5 GB/s. Therefore, the sum thereof is 11.5 GB/s, which is smaller than 12 GB/s of the block performance of the host provisioning FE IF 110.

In a case where the host provisioning FE IF block performance is equal to or more than the sum of the block performance requirement and the basic configuration backup block performance (S804: NO), the management apparatus 50 selects the basic configuration as the backup configuration to be set for the storage system 1 (S805).

In a case where the host provisioning FE IF block performance is smaller than the sum of the block performance requirement and the basic configuration backup block performance (S804: YES), the management apparatus 50 selects the backup configuration 2 as the backup configuration to be set for the storage system 1 (S806).

After the backup configuration is determined, the management apparatus 50 sets the backup configuration information of the FE IF pair that performs the backup processing from the determined backup configuration and the backup configuration management information T3 (S808).

As described above, in the present embodiment, an appropriate backup configuration can be determined on the basis of the state of the storage system 1, that is, the network performance and the performance of the FE IFs 110. Note that one of the backup configuration 1, the backup configuration 2, and the basic configuration may be excluded from the selection candidates. Determination conditions for excluded backup configuration candidates may be omitted. For example, in a case where the basic configuration is excluded, steps S802 and S804 may be omitted. In a case where the backup configuration 1 is omitted, step S803 is omitted, and the process flow can advance to step S804 as a result of a YES determination in step S802. In a case where the backup configuration 2 is omitted, step S804 is omitted, and the basic configuration can be selected by a NO determination in step S803.

### Sixth Embodiment

Other embodiments of the present specification will be described hereinbelow. The present embodiment describes a method for selecting a backup configuration to be applied to the storage system 1 from among a plurality of backup configuration candidates. Specifically, an appropriate backup configuration is selected from the backup configuration (configuration 3 (third backup configuration)) described in the third embodiment and the backup configuration (configuration 4 (fourth backup configuration)) described in the fourth embodiment.

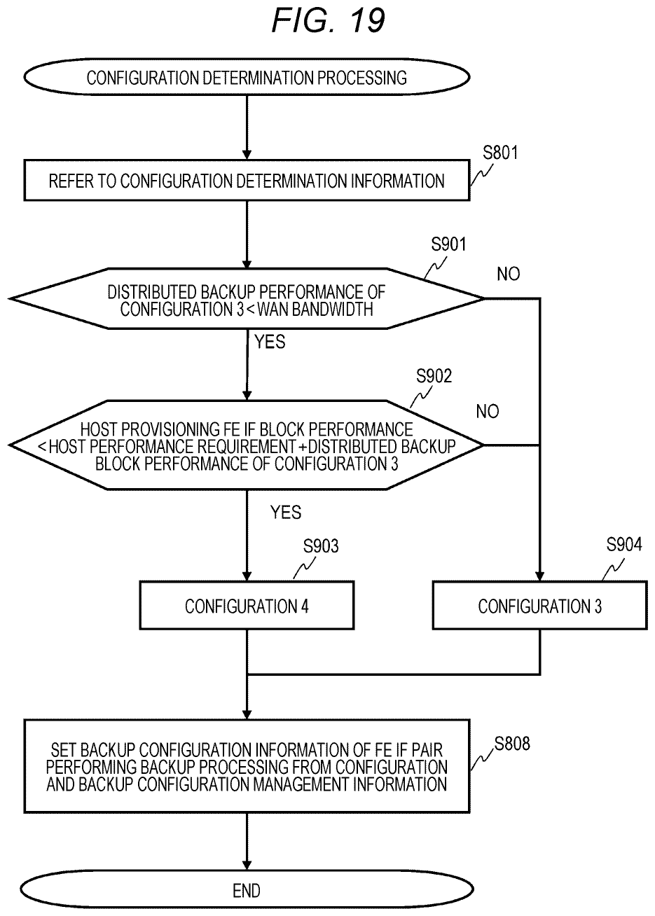

FIG. 19 shows a flowchart of backup configuration determination processing according to a sixth embodiment. Note that, in the present embodiment, information referred to for determination and setting of the backup configuration having the configuration described with reference to FIGS. 16 and 17 is prepared in advance. In addition, an example in which the management apparatus 50 executes the processing will be described below, but the subject is not particularly limited.

The management apparatus 50 refers to the configuration information (S801) and compares the distributed backup performance and the WAN performance of the backup configuration 3 (S901). The distributed backup performance of the backup configuration 3 is a product of the backup performance of the basic configuration and the number of FE IFs that execute backup processing. In this example, the value is two times the backup performance of the basic configuration.

In a case where the distributed backup performance of the backup configuration 3 is equal to or higher than the WAN performance (S901: NO), the management apparatus 50 selects the backup configuration 3 as the backup configuration set for the storage system 1 (S904).

In a case where the distributed backup performance of the backup configuration 3 is lower than the WAN performance (S901: NO), the management apparatus 50 compares the host provisioning FE IF block performance with a value obtained by adding the basic configuration distributed backup block performance to the host performance requirement (S902).

The distributed backup block performance of the configuration 3 is represented by the product of block performance per FE IF 110 executing the backup program P11 and the block protocol server program P15 and the number of these FE IFs 110. For example, the block performance per FE IF 110 is ½ of the block performance of the FE IF 110 executing only block processing, and the number of these FE IFs 110 is two.

In a case where the host provisioning FE IF block performance is smaller than the value obtained by adding the distributed backup block performance of the configuration 3 to the host performance requirement (S902: YES), the management apparatus 50 selects the backup configuration 4 as the backup configuration to be set for the storage system 1 (S903). Otherwise (S902: NO), the management apparatus 50 selects the backup configuration 3 as the backup configuration set for the storage system 1 (S904).

As described above, in the present embodiment, an appropriate backup configuration can be determined on the basis of the state of the storage system 1, that is, the network performance and the performance of the FE IFs 110. Note that backup configurations different from the backup configurations 1 to 4 and the basic configuration may be prepared as selection candidates, and some of the backup configurations may be excluded from the selection candidates. In the fifth and sixth embodiments, the apparatus performs only a backup configuration determination, and the setting thereof may be performed by another entity. Some of the determination conditions may also be omitted or other determination conditions may be added.

Note that the present invention is not limited to or by the above-described embodiments and includes various modifications. For example, the above-described embodiments have been described in detail to facilitate understanding of the present invention, and the present invention is not necessarily limited to or by embodiments having all the configurations described. In addition, part of the configuration of one embodiment can be replaced with the configuration of another embodiment, and the configuration of the other embodiment can also be added to the configuration of the one embodiment. Moreover, it is possible to add other configurations to part of the configuration of each embodiment, and to delete or substitute part of the configurations of the embodiments.

In addition, some or all of the above-described configurations, functions, processing parts and the like may be implemented by hardware, for example, by a design using an integrated circuit. Furthermore, each of the above-described configurations, functions, and the like may be implemented by software as a result of the processor parsing and executing a program that implements the respective functions. Information such as programs, tables, and files for implementing each function can be stored on recording devices such as memory, a hard disk, or an SSD, or on a recording medium such as an IC card or an SD card.

Moreover, control lines and information lines that are considered necessary for the sake of the description are shown, and not all control lines and information lines are necessarily shown for a product. In practice, almost all the configurations may be considered to be connected to each other.

What is claimed is:

1. An apparatus for determining a backup configuration of a storage system, the apparatus comprising:
a processor; and
a memory apparatus,
wherein the storage system includes a plurality of front-end interfaces,
wherein the memory apparatus stores configuration determination information,
the configuration determination information including:
network performance information indicating performance of a network between the storage system and a backup destination,
interface performance information indicating performance of the plurality of front-end interfaces, and
performance requirement information indicating a performance requirement for a host IO, and
wherein the processor determines, on the basis of the configuration determination information, a front-end interface that reads backup data and a front-end interface that transmits the backup data to the backup destination.

2. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination, and
wherein the plurality of backup configurations includes a first backup configuration,
the first backup configuration including:
a multi-host provisioning front-end interface that executes host IO processing,
a backup front-end interface that is excluded from the host IO processing and from reading of the backup data and that transmits the backup data to the backup destination, and
a backup data reading front-end interface that is excluded from the host IO processing and from processing to transmit the backup data to the backup destination and that reads the backup data.

3. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination, and
wherein the plurality of backup configurations includes a second backup configuration,
the second backup configuration including:
a multi-host provisioning front-end interface that executes host IO processing, and
a backup front-end interface that is excluded from the host IO processing and from reading of the backup data and that transmits the backup data to the backup destination, and
wherein the backup front-end interface acquires the backup data from the multi-host provisioning front-end interface.

4. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a first backup configuration and a basic configuration,
the first backup configuration including:
a multi-host provisioning front-end interface that executes host IO processing,
a backup front-end interface that is excluded from the host IO processing and from reading of the backup data and that transmits the backup data to the backup destination, and
a backup data reading front-end interface that is excluded from the host IO processing and from processing to transmit the backup data to the backup destination and that reads the backup data, and
the basic configuration including:
a multi-host provisioning front-end interface that executes host IO processing,
a single basic backup front-end interface that is excluded from the host IO processing and that reads the backup data and transmits the backup data to the backup destination, and
wherein the processor refers to the configuration determination information to:
select the basic configuration in a case where the backup performance of the basic configuration is equal to or greater than the bandwidth of a network to the backup destination, and
select the first backup configuration in a case where the backup performance of the basic configuration is less than the bandwidth of the network to the backup destination and where the backup network bandwidth is greater than a predetermined performance requirement for the backup.

5. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a second backup configuration and a basic configuration,
the second backup configuration including:
a multi-host provisioning front-end interface that executes host IO processing,
a backup front-end interface that is excluded from the host IO processing and from reading of the backup data and that transmits the backup data to the backup destination,
the backup front-end interface acquiring the backup data from the multi-host provisioning front-end interface, and
the basic configuration including:
a multi-host provisioning front-end interface that executes host IO processing, and
a single basic backup front-end interface that is excluded from the host IO processing and that reads the backup data and transmits the backup data to the backup destination, and
wherein the processor refers to the configuration determination information to:
select the basic configuration in a case where the backup performance of the basic configuration is equal to or greater than the bandwidth of a network to the backup destination, and
select the second backup configuration in a case where the backup performance of the basic configuration is less than the bandwidth of the network to the backup destination and where a value obtained by adding the data reading performance of the basic backup front-end interface to the performance requirement for the host IO processing is greater than the data reading performance of the multi-host provisioning front-end interface.

6. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a first backup configuration and a second backup configuration,
the first backup configuration including:
a multi-host provisioning front-end interface that executes host IO processing,
a backup front-end interface that is excluded from the host IO processing and from reading of the backup data and that transmits the backup data to the backup destination, and
a backup data reading front-end interface that is excluded from the host IO processing and from processing to transmit the backup data to the backup destination and that reads the backup data, and
the second backup configuration including:
a multi-host provisioning front-end interface that executes host IO processing, and
a backup front-end interface that is excluded from the host IO processing and from reading of the backup data and that transmits the backup data to the backup destination,
the backup front-end interface acquiring the backup data from the multi-host provisioning front-end interface, and
wherein the processor refers to the configuration determination information to:
select the first backup configuration in a case where the backup network bandwidth is greater than a predetermined performance requirement for the backup, and
select the second backup configuration in a case where the backup network bandwidth is equal to or less than the predetermined performance requirement for the backup.

7. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a first backup configuration, a second backup configuration, and a basic configuration,
the first backup configuration including:
a multi-host provisioning front-end interface that executes host IO processing,
a backup front-end interface that is excluded from the host IO processing and from reading of the backup data and that transmits the backup data to the backup destination, and
a backup data reading front-end interface that is excluded from the host IO processing and from processing to transmit the backup data to the backup destination and that reads the backup data,
the second backup configuration including:
a multi-host provisioning front-end interface that executes host IO processing, and
a backup front-end interface that is excluded from the host IO processing and from reading of the backup data and that transmits the backup data to the backup destination,
the backup front-end interface acquiring the backup data from the multi-host provisioning front-end interface, and
the basic configuration including:
a multi-host provisioning front-end interface that executes host IO processing, and
a single basic backup front-end interface that is excluded from the host IO processing and that reads the backup data and transmits the backup data to the backup destination, and
wherein the processor refers to the configuration determination information to:
select the basic configuration in a case where the backup performance of the basic configuration is equal to or greater than the bandwidth of a network to the backup destination,
select the first backup configuration in a case where the backup performance of the basic configuration is less than the bandwidth of the network to the backup destination and where the backup network bandwidth is greater than a predetermined performance requirement for the backup,
select the second backup configuration in a case where the backup performance of the basic configuration is less than the bandwidth of the network to the backup destination, where the backup network bandwidth is equal to or greater than the predetermined performance requirement for the backup, and where a value obtained by adding the data reading performance of the basic backup front-end interface to the performance requirement for the host IO processing is greater than the data reading performance of the multi-host provisioning front-end interface, and
select the basic configuration in a case where the backup performance of the basic configuration is less than the bandwidth of the network to the backup destination, where the backup network bandwidth is equal to or greater than the predetermined performance requirement for the backup, and where a value obtained by adding the data reading performance of the basic backup front-end interface to the performance requirement for the host IO processing is equal to or less than the data reading performance of the multi-host provisioning front-end interface.

8. The apparatus according to claim 2,
wherein, in a case where a fault occurs in one of the backup front-end interface and the backup data reading front-end interface, the other of the backup front-end interface and the backup data reading front-end interface executes reading of the backup data and transmission of the backup data to the backup destination.

9. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a third backup configuration,
the third backup configuration including:
a multi-host provisioning front-end interface that executes host IO processing, and a plurality of basic backup front-end interfaces, and
wherein each of the plurality of basic backup front-end interfaces are excluded from the host IO processing and executes reading of the backup data and transmission of the backup data to the backup destination.

10. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a fourth backup configuration,
the fourth backup configuration including:
a multi-host provisioning front-end interface that executes host IO processing, and a plurality of backup front-end interfaces, and
wherein each of the plurality of backup front-end interfaces is excluded from the host IO processing and from reading of the backup data and transmits the backup data acquired from the host provisioning front-end interface to the backup destination.

11. The apparatus according to claim 1,
wherein the processor determines a backup configuration to be set from among a plurality of backup configuration candidates,
wherein each of the plurality of backup configuration candidates indicates a front-end interface that reads the backup data and a front-end interface that transmits the backup data to a backup destination,
wherein the plurality of backup configurations includes a third backup configuration and a fourth backup configuration,
the third backup configuration including:
a multi-host provisioning front-end interface that executes host IO processing, and a plurality of basic backup front-end interfaces,
wherein each of the plurality of basic backup front-end interfaces are excluded from the host IO processing and executes reading of the backup data and transmission of the backup data to the backup destination, and
the fourth backup configuration including:
a multi-host provisioning front-end interface that executes host IO processing, and a plurality of backup front-end interfaces,
wherein each of the plurality of backup front-end interfaces is excluded from the host IO processing and from reading of the backup data and transmits the backup data acquired from the host provisioning front-end interface to the backup destination, and
wherein the processor refers to the configuration determination information to:
select the third backup configuration in a case where the backup performance of the third backup configuration is equal to or greater than the performance of the network to the backup destination,
select the fourth backup configuration in a case where the backup performance of the third backup configuration is less than the performance of the network to the backup destination, and where a value obtained by adding the data reading performance of the plurality of basic backup front-end interfaces to the performance requirement for the host IO processing is greater than the data reading performance of the multi-host provisioning front-end interface, and
select the third backup configuration in a case where the backup performance of the third backup configuration is less than the performance of the network to the backup destination, and where a value obtained by adding the data reading performance of the plurality of basic backup front-end interfaces to the performance requirement for the host IO processing is equal to or less than the data reading performance of the multi-host provisioning front-end interface.

12. A method for determining a backup configuration of a storage system,
the storage system including a plurality of front-end interfaces,
the method comprising:
referring to configuration determination information,
the configuration determination information including:
network performance information indicating performance of a network between the storage system and a backup destination, interface performance information indicating performance of the plurality of front-end interfaces, and
performance requirement information indicating a performance requirement for a host IO; and
determining, on the basis of the configuration determination information, a front-end interface that reads backup data and a front-end interface that transmits the backup data to the backup destination.
